(19) United States
(12) Patent Application Publication
(10) Pub. No.: US 2011/0082876 A1
(43) Pub. Date: Apr. 7, 2011

(54) COMPUTER SYSTEM AND METHOD FOR PROVIDING ASSISTANCE IN THE PREPARATION OF A PATENT APPLICATION

(75) Inventors: Shey-Shi Lu, Taipei (TW); Chih-Kung Lee, Taipei (TW); Hung-Wei Chiu, Taipei (TW); Yung-Chin Wang, Taipei (TW)

(73) Assignee: National Taiwan University, Taipei (TW)

(21) Appl. No.: 12/762,956

(22) Filed: Apr. 19, 2010

(30) Foreign Application Priority Data
Oct. 1, 2009 (TW) 098133388

(51) Int. Cl. G06F 17/30; H04N 5/44

(52) U.S. Cl. 707/769; 707/802; 348/725; 707/E17.044; 707/E17.014; 707/781; 707/E17.005; 348/E05.096

(57) ABSTRACT

A computer system capable of providing assistance in the preparation of a patent application is provided. The computer system includes a database group. The database group includes a case database for storing a case file. The case database includes a drawing data storage for storing at least one drawing of an embodiment of an invention that is the subject of a patent application and that corresponds to the case file. The at least one drawing includes at least one component reference numeral. The case database further includes a component description data storage for storing component-descriptive text of at least one component of the embodiment that corresponds to the case file, the at least one component corresponding to the at least one component reference numeral included in the at least one drawing stored in the drawing data storage.

### CROSS-REFERENCE TO RELATED APPLICATION

This application claims priority to Taiwanese Application No. 098133388, filed on Oct. 1, 2009, the disclosure of which is incorporated herein by reference.

### BACKGROUND OF THE INVENTION

1. Field of the Invention

The invention relates to a computer system, and more particularly to a computer system and method capable of providing assistance in the preparation of a patent application.

2. Description of the Related Art

Current methods of patent preparation may involve drafting of a patent specification by a patent practitioner using a word processor. The initial draft may be reviewed and edited by an additional person, such as the inventor. One example of a patent drafting system is disclosed in U.S. Pat. No. 6,434,580 entitled “System, Method, and Recording Medium for Drafting and Preparing Patent Specifications,” which includes first, second and third computers to allow transmission of a draft patent specification from one person to another for editing and review. Although the disclosed system may assist with transmission of the draft specification, preparation of the draft specification primarily relies upon a user's preferred writing style to form sentences within the draft independently. The user's independent creation of sentences within the draft may allow grammatical or technical errors to be generated through the user's inexperience, oversight, or fatigue. A reviewer of the work may also fail to catch such errors in the patent application, potentially resulting in a defective application. Accordingly, additional improvements in the disclosed conventional patent drafting system may still be made.

### SUMMARY OF THE INVENTION

An object of the present invention is to provide a computer system and method capable of providing assistance in the preparation of a patent application.

According to an embodiment, the computer system includes a database group that includes a case database for storing a case file. The case database includes a drawing data storage for storing at least one drawing of an embodiment of an invention that is the subject of a patent application and that corresponds to the case file. The at least one drawing includes at least one component reference numeral. The case database further includes a component description data storage for storing component-descriptive text of at least one component of the embodiment that corresponds to the case file. The at least one component corresponds to the at least one component reference numeral included in the at least one drawing stored in the drawing data storage. The case database further includes an invention description data storage for storing embodiment-descriptive text of the embodiment that corresponds to the case file.

The computer system further includes a processing device coupled to the database group. The processing device includes a descriptive-text building module for building raw embodiment-descriptive text that corresponds to the case file in accordance with a text-building rule and that is based on the at least one component reference numeral of the at least one drawing stored in the drawing data storage, and the component-descriptive text stored in the component description data storage. The descriptive-text building module further stores the raw embodiment-descriptive text in the invention description data storage.

An embodiment of this invention has an advantage of making it easier to prepare a patent application.

### BRIEF DESCRIPTION OF THE DRAWINGS

Other features and advantages of embodiments of the present invention will become apparent in the following detailed description of the preferred embodiments with reference to the accompanying drawings, of which:

FIG. 1 is a schematic diagram illustrating a computer system capable of providing assistance in the preparation of a patent application and coupled to a plurality of user terminals through a communications network;

FIG. 2 is a schematic block diagram illustrating a processing device and a database group of a preferred embodiment;

FIG. 3 is a block diagram illustrating how embodiment-descriptive text is built using a descriptive-text building module;

FIG. 4 is a flowchart of a preferred embodiment illustrating steps to build embodiment-descriptive text;

FIG. 5 is a flowchart of a preferred embodiment illustrating steps to provide a display of alternative terms;

FIG. 6 is a flowchart of a preferred embodiment illustrating steps to inspect a claim using a preset claim drafting rule;

FIG. 7 is a flowchart of a preferred embodiment illustrating a login procedure;

FIG. 8 is an illustration of an entry interface of a preferred embodiment;

FIG. 9 is a block diagram illustrating communication of a composite video signal between a video signal processing module and an editing-communication interface in accordance with a preferred embodiment;

FIG. 10 is an illustration of a composite video image of a preferred embodiment;

FIG. 11 is an illustration of a case editing interface of a preferred embodiment;

FIG. 12 is an illustration of a specification editing interface of a preferred embodiment; and

FIG. 13 is an illustration of a claim editing interface of a preferred embodiment.

### DETAILED DESCRIPTION OF THE PREFERRED EMBODIMENTS

Before embodiments of the present invention are described in greater detail with reference to the accompanying preferred embodiments, it should be noted herein that like elements are denoted by the same reference numerals throughout the disclosure.

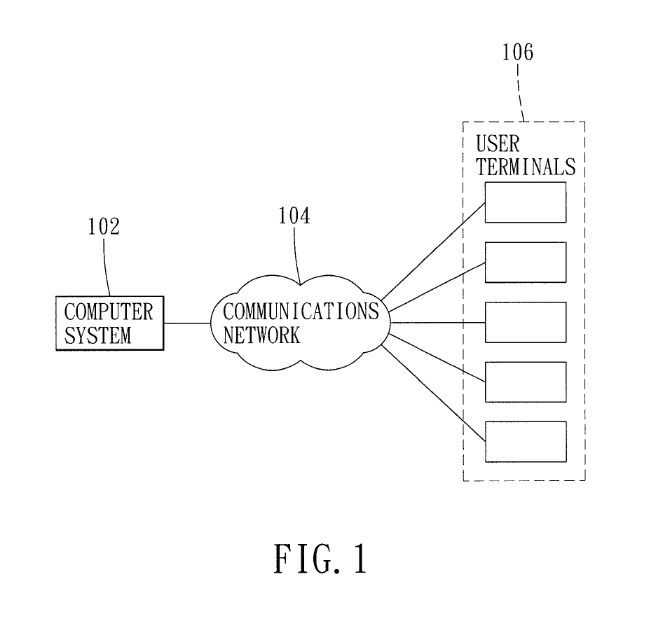

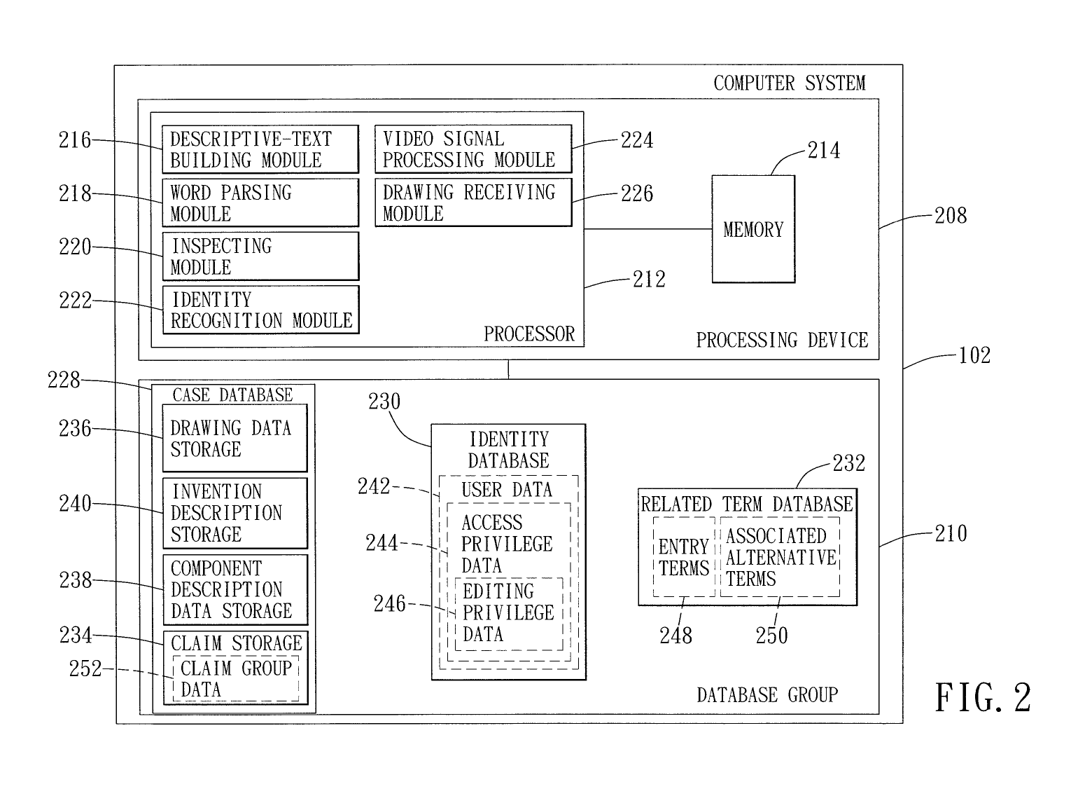

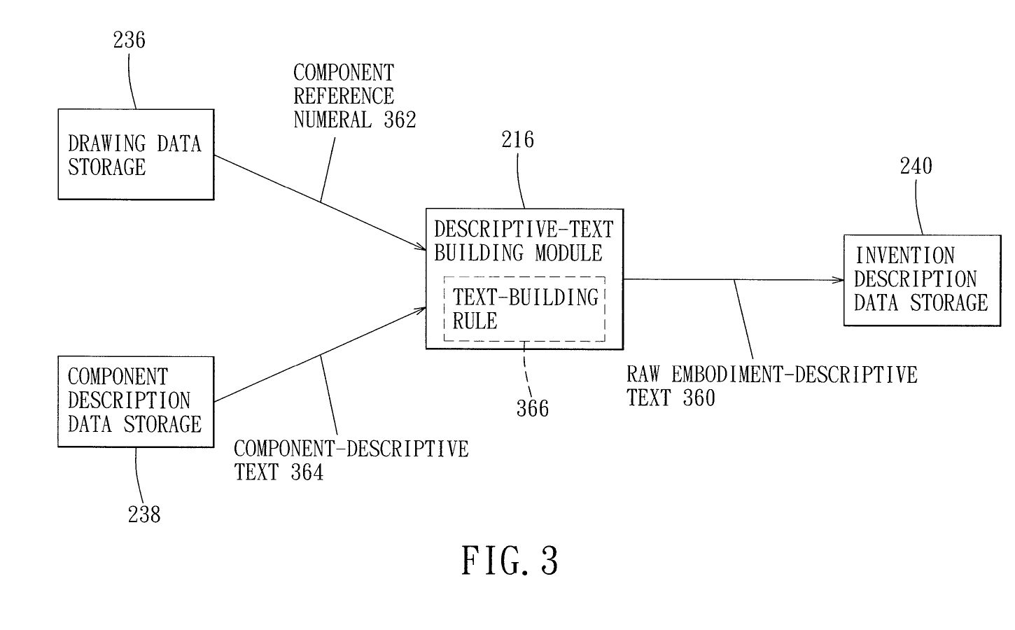

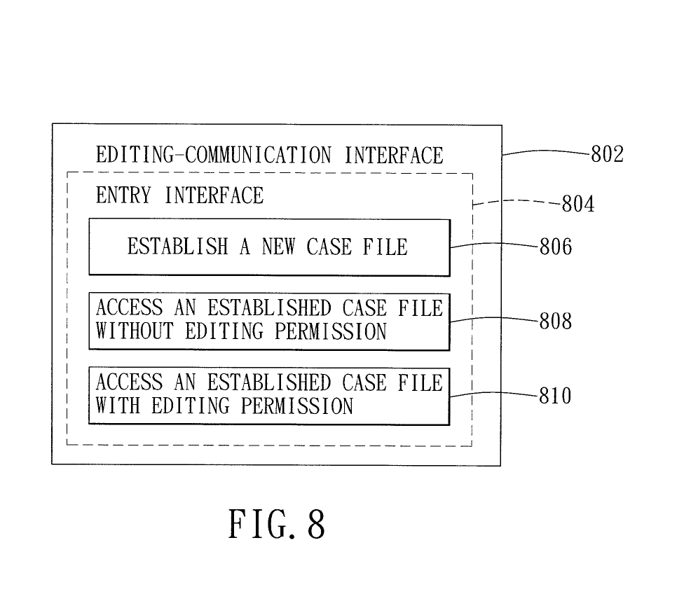

Components of a preferred embodiment of a computer system 102 as well as its communication with other devices through a communications network 104 are illustrated in FIGS. 1 and 2. Operation of the computer system 102 may be better understood from the flowcharts and block diagrams illustrated in FIGS. 3 to 7, and 9. In addition, FIGS. 8 and 10 to 13 illustrate interfaces that may be provided through an editing-communication interface 802 of FIG. 8 to assist in preparation of a patent application. The editing-communication interface 802 may allow cooperative and simultaneous group editing of a case file by providing a common display for each user participating in group editing of a case file. In addition, the editing-communication interface 802 may be used to edit the contents of a patent application case file, including drawings, text, component numbering, and other data, and may further be used to provide video communication among users of the computer system 102. In an embodiment, the editing-communication interface 802 is developed using one of the web page programming languages of the group of a hypertext pre-processor (PHP), an active server page (ASP), Ruby on Rails, and Java service page (JSP).

FIG. 1 is a schematic diagram illustrating a computer system 102 capable of providing assistance in the preparation of a patent application and coupled to a plurality of user terminals 106 through a communications network 104. The computer system 102 may be a general purpose computer or a server, and the user terminals 106 may include a general purpose computer, a mobile device, a terminal supported by a separate computer, or other devices. The communications network 104 may include a local area network, a wide area network, or any other type of computer network. The computer system 102 may use a network interface device (not illustrated) to communicate with the user terminals 106 through the communications network 104.

The computer system 102 may be operated directly, and the computer system 102 may provide assistance to users of the user terminals 106. The users of the computer system 102 or the user terminals 106 may include patent engineers, attorneys, inventors, or other draft editors.

FIG. 2 is a schematic block diagram illustrating a processing device 208 and a database group 210 of a preferred embodiment of the computer system 2. The processing device 208 includes a processor 212 and a memory 214 loaded with program instructions (i.e., software or firmware) to be executed by the processor 212, thereby configuring the processor 212 to serve as a descriptive-text building module 216, a word parsing module 218, an inspecting module 220, an identity recognition module 222, a video signal processing module 224, and a drawing receiving module 226. The processor 212 may execute application programs and may be connected to the database group 210 using a bus and a bus controller (not illustrated) to allow transfer of data to and from the databases within the database group 210.

The database group 210 includes a case database 228, an identity database 230, and a related term database 232, which may be implemented using physical storage devices or storage mediums such as a hard drive, RAM, a RAID array, or an optical disc. The case database 228 includes a drawing data storage 236, a component description data storage 238, an invention description storage 240, and a claim storage 234, each of which may be implemented using a storage device and may include data stored within the case database 228. The case database 228 may store a case file that includes a drawing, components of an embodiment of an invention that is the subject of a patent application to be prepared using the computer system 102, component reference numerals 362 (shown in FIG. 3) that correspond to the components of the embodiment, and patent claims.

In particular, the drawing data storage 236 is for storing at least one drawing of the embodiment of the invention that is the subject of a patent application and that corresponds to the case file, the at least one drawing including at least one component reference numeral 362. The component description data storage 238 is for storing component-descriptive text 364 (shown in FIG. 3) of at least one component of the embodiment that corresponds to the case file, the at least one component corresponding to the at least one component reference numeral 362 included in the at least one drawing stored in the drawing data storage 236. The invention description data storage 240 is for storing embodiment-descriptive text 360 (shown in FIG. 3) of the embodiment that corresponds to the case file. The claim storage 234 is for storing claim group data 252 that includes one or more claims directed to the invention corresponding to the case file.

The identity database 230 may store user data 242 that includes access privilege data 244, which in turn may include editing privilege data 246. The access privilege data 244 and the editing privilege data 246 may be configured by a person establishing a case file, e.g., when the case file is established. The related term database 232 may store a group of one or more entry terms 248 along with associated alternative terms 250. The alternative terms 250 may include synonyms of the entry terms 248.

FIG. 3 is a block diagram to illustrate how raw embodiment-descriptive text 360 is built using a descriptive-text building module 216. The descriptive-text building module 216 acquires the component reference numeral 362 from the drawing data storage 236 and acquires the associated component-descriptive text 364 from the component description data storage 238. The descriptive-text building module 216 then builds the raw embodiment-descriptive text 360 in accordance with a text-building rule 366 using the component reference numeral 362 and the component-descriptive text 364. The raw embodiment-descriptive text 360 is stored in the invention description data storage 240.

The raw embodiment-descriptive text 360 may be built based on an ordered sequence of the components of an embodiment associated with the case file. The ordered sequence may be determined based on hierarchical relations among the component reference numerals 362 corresponding to the components of the embodiment. The descriptive-text building module 216 may generate an error message if a text-building rule 366 or a hierarchical relationship has not been determined or selected. The raw embodiment-descriptive text 360 may be approved or modified by a user to form the embodiment-descriptive text of a completed patent application.

The hierarchical relations may organize components and sub-components of an embodiment by matching a leading digit of the respective component reference numerals 362 to identify related components. Taking components with the same leading digit in the component reference numerals 362 thereof as an example, a first component with less digits in its associated component reference numeral 362 than a second component includes the second component as a sub-component thereof. In other words, components with associated two-digit component reference numerals 362 and a leading digit “5” will be classified as sub-components of the component with the associated single-digit component reference numeral 362 “5.” Similarly, components with associated three-digit component reference numerals 362 and leading digits “55” will be classified as sub-components of the component with the associated two-digit component reference numeral 362 “55.”

For example, a component of an embodiment may correspond to component-descriptive text 364 of “a chair” and a component reference numeral 362 of “5.”Additional components of the embodiment may be associated with component-descriptive text 364 of a “chair leg,” a “seat,” and a “backrest,” and associated respectively with component reference numerals 362 “51, ” “52,” and “53.” Based on the hierarchical relations, the matching leading digit of “5” indicates that the components are associated. In addition, the double digits in the component reference numerals 362 of the “chair leg,” the “seat,” and the “backrest” indicate that these components are sub-components of the “chair,” which is associated with a single-digit component reference numeral 362 of “5.”

The text-building rule 366 may indicate that a component is associated with its sub-components. For example, the text-building rule 366 may include a sentence building framework indicating that: A includes A1 through An. The number “n” is equal to a quantity of sub-components.

Accordingly, the raw embodiment-descriptive text 360 may be used to build the following sentence in accordance with a text-building rule 366: “The chair 5 includes a chair leg 51, a seat 52, and a backrest 53.” The term “includes” in the sentence above may be replaced by “consists of,” “comprises,” “consists essentially of,” or any other terms input into the computer system 102.

The hierarchical relationship may be determined when the component-descriptive text 364 of a component is entered by a user and received by the computer system 102. For example, the computer system 102 may present a user with an option to select sub-components or otherwise related components of an embodiment stored in the case database 228 when component-descriptive text 364 of a component is entered into the computer system 102.

The hierarchical relationship may be determined with reference to a drawing, in which the components of the embodiment and their relationships are identified by a user. For example, a user may identify a point in a drawing with a component-reference numeral 362 and an associated component-descriptive text 364 using the computer system 102. The computer system 102 may then present the user with an option to identify associated components and sub-components of the embodiment based on a currently accessed drawing or with reference to a list of component-descriptive text 364 stored in the case database 228.

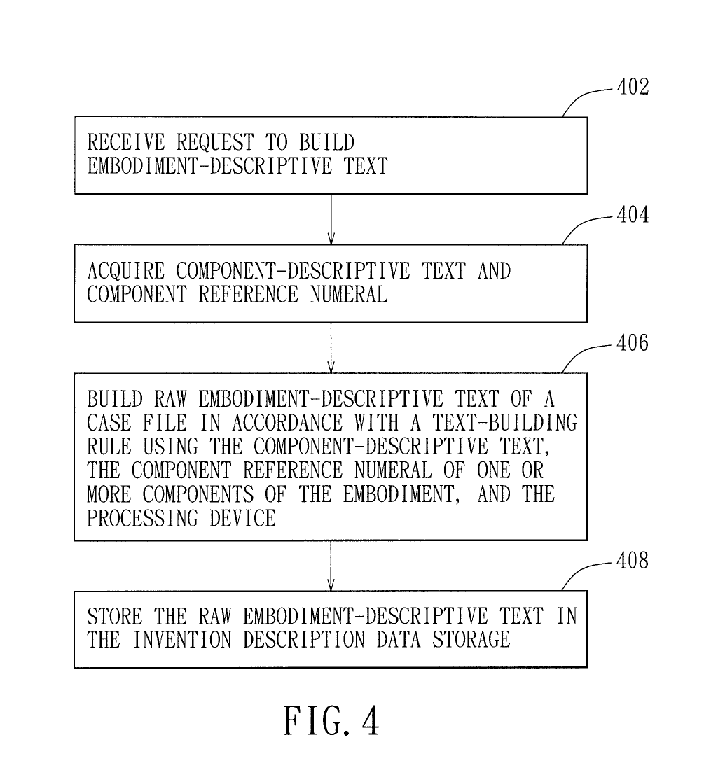

FIG. 4 is a flowchart of a preferred embodiment illustrating steps to build embodiment-descriptive text. In step 402, a request to build embodiment-descriptive text is received. In an embodiment, the request is input by a user operating a user terminal 106 or the computer system 102 and is processed using the descriptive-text building module 216.

In step 404, the component-descriptive text 364 and the component reference numeral 362 of one or more components of the embodiment of the invention are acquired. The descriptive-text building module 216 may acquire the component reference numeral 362 from the drawing data storage 236 and the component-descriptive text 364 from the component description data storage 238.

In step 406, the component-descriptive text 364, the component reference numeral 362 of one or more components of the embodiment, and the processing device 208 are used to build raw embodiment-descriptive text 360 of a case file in accordance with a text-building rule 366. As described above, the raw embodiment-descriptive text 360 may be built based on an ordered sequence of the components of the embodiment, and the ordered sequence may be based on a hierarchical relationship of the reference numerals 362 of the components. In step 408, the raw embodiment-descriptive text 360 is stored in the invention description data storage 240.

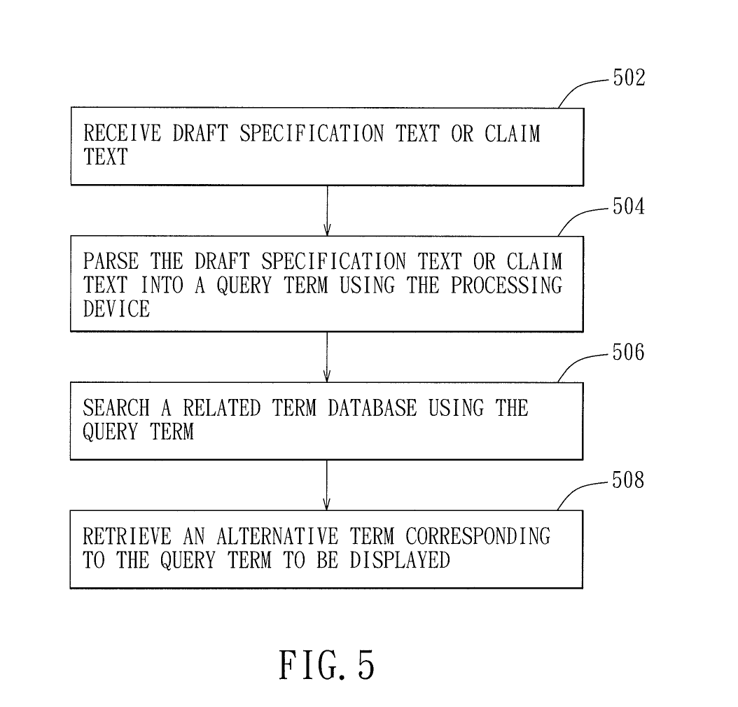

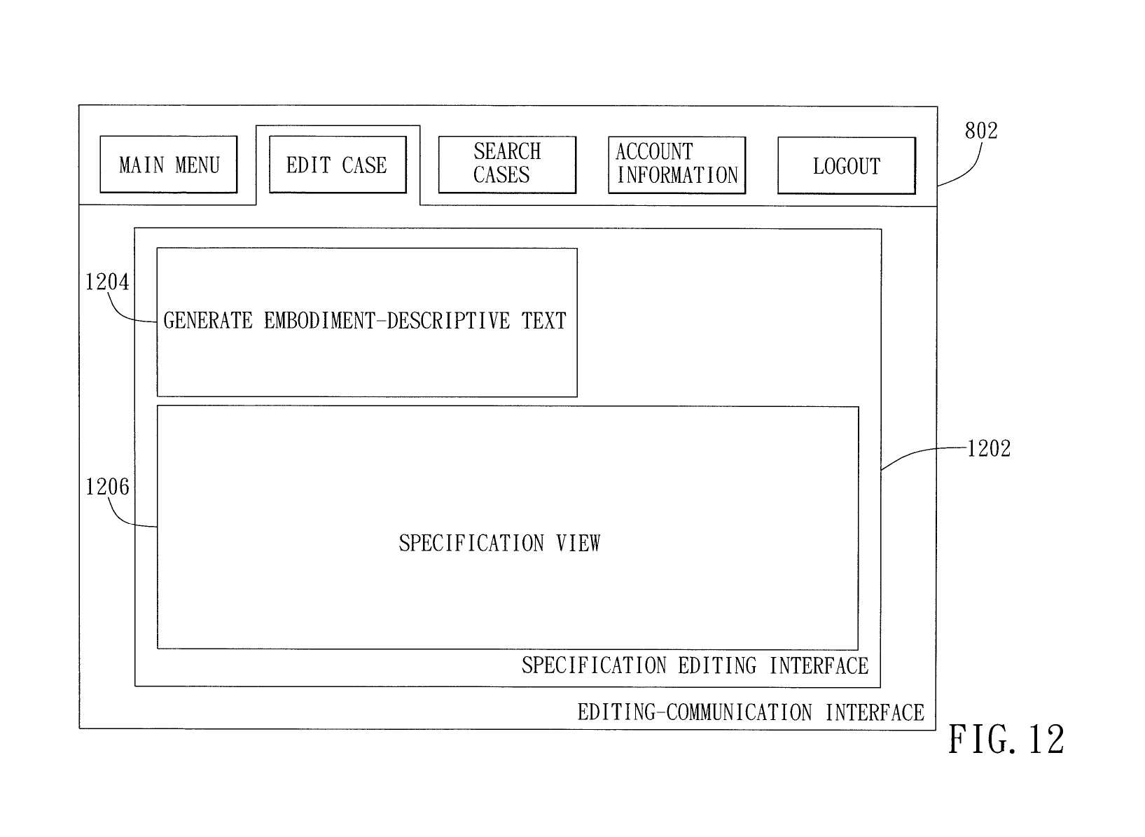

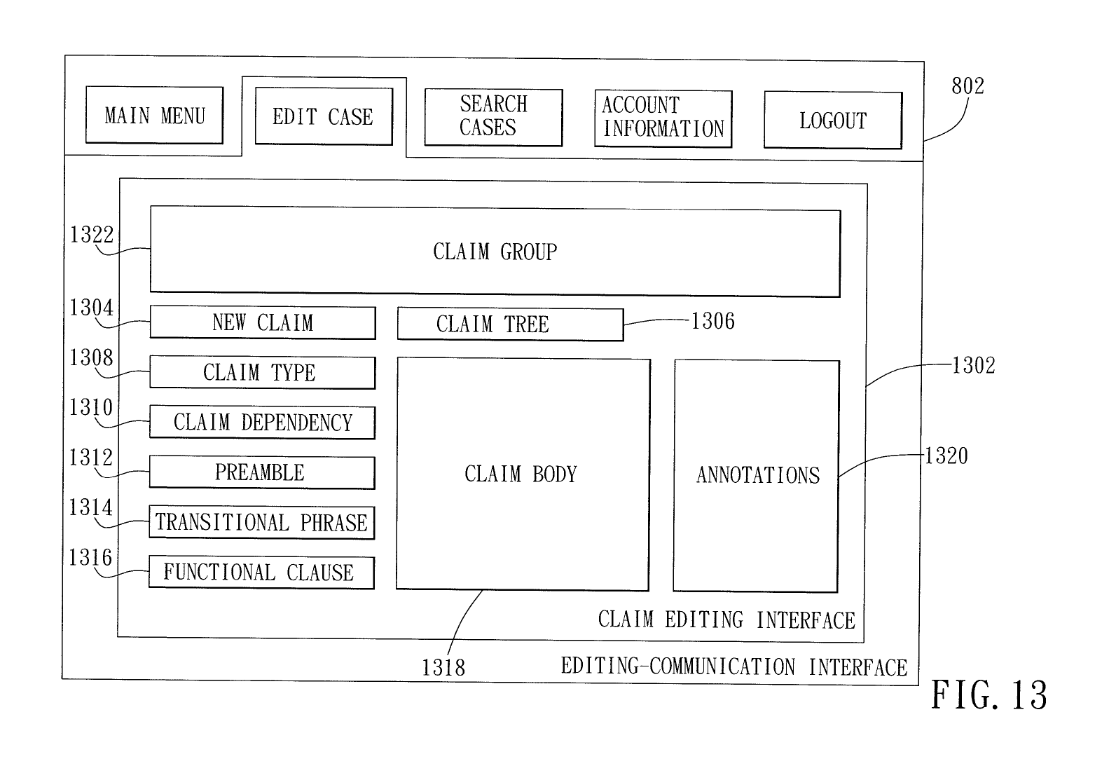

FIG. 5 is a flowchart of a preferred embodiment illustrating steps to provide a display of alternative terms 250. In step 502, draft specification text or claim text is received. In an embodiment, the word parsing module 218 monitors user access to either a claim editing interface 1302 of FIG. 13 or a specification drafting interface 1202 of FIG. 12. When a word, phrase, or sentence is input into a user interface, the word parsing module 218 detects and obtains the input text.

In step 504, the draft specification text or claim text is parsed into a query term using a processing device 208. In an embodiment, the word parsing module 218 parses the claim text by identifying individual words separated by non-text characters. The word parsing module 218 may further identify a verb, a noun, an adverb, an adjective, a pronoun, a preposition, or an interjection in order to select a query term. The query term may be composed of a word or phrase within the input text, and it may be automatically selected by the word parsing module 218 or determined by a query selection signal generated from a user input.

In step 506, the query term is used to search a related term database 232. The query term may be used to identify a matching entry term 248. In step 508, an alternative term 250 corresponding to the query term is retrieved for subsequent display. The alternative term 250 may correspond to an entry term 248 that substantially matches with the query term. The alternative term 250 may have the same meaning, a similar meaning, or a related meaning to the query term. The alternative term 250 may be displayed through the editing-communication interface 802, such as through the specification editing interface 1202 of FIG. 12 or the claim editing interface 1302 of FIG. 13.

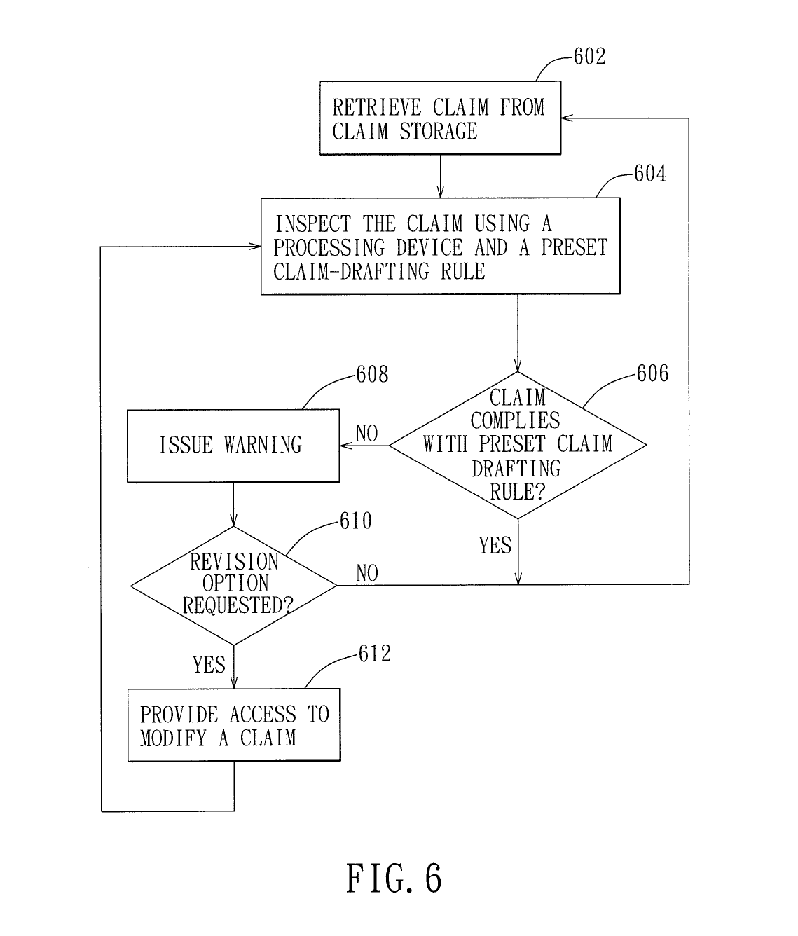

FIG. 6 is a flowchart of a preferred embodiment illustrating steps to inspect a claim using a preset claim-drafting rule. In step 602, a claim is retrieved from the claim storage 234. In an embodiment, the inspecting module 220 may retrieve the claim from the claim group data 252 in the claim storage 234 for inspection to verify whether or not it complies with one or more preset claim-drafting rules. In step 604, the claim is inspected using the processing device 208 and a preset claim-drafting rule. In step 606, whether or not the claim complies with the preset rule is determined. If the claim does not comply, in step 608, a warning is issued. If the claim does comply, the inspection of the claim is completed, and the flow goes back to step 602 to inspect another claim. After step 608, in step 610, whether or not a revision option is selected is determined. If the revision option is selected, in step 612, access to modify the claim is provided, after which the process returns to step 604 to allow inspection of the revised claim.

In an embodiment, the preset claim-drafting rule states that the preamble of a dependent claim should match at least a part of the preamble of a base claim. The base claim is a claim on which the dependent claim depends, and the base claim may be an independent claim or a dependent claim. In order to determine compliance with this rule, the inspecting module 220 may identify the preamble of the dependent claim as the initial text of the dependent claim between an article, if one is present, and an identification of the base claim, such as a statement “of claim 1.” The article may be one of the words “a,” “an,” or “the.”

The inspecting module 220 may then compare the identified preamble of the dependent claim with a base claim preamble. If the identified preamble matches with at least a portion of the base claim preamble, then the inspecting module 220 determines that the dependent claim complies with the rule. If a match is not found, the inspecting module 220 generates a warning signal to indicate that the dependent claim may not comply with the rule. The inspecting module 220 may then provide an option to revise the dependent claim to comply with the base claim through the editing-communication interface 802.

Alternatively, the preset claim-drafting rule may state that a multiple dependent claim should not depend on another multiple dependent claim. The preset claim-drafting rule may include other claim-drafting rules and may be revised or adapted as needed.

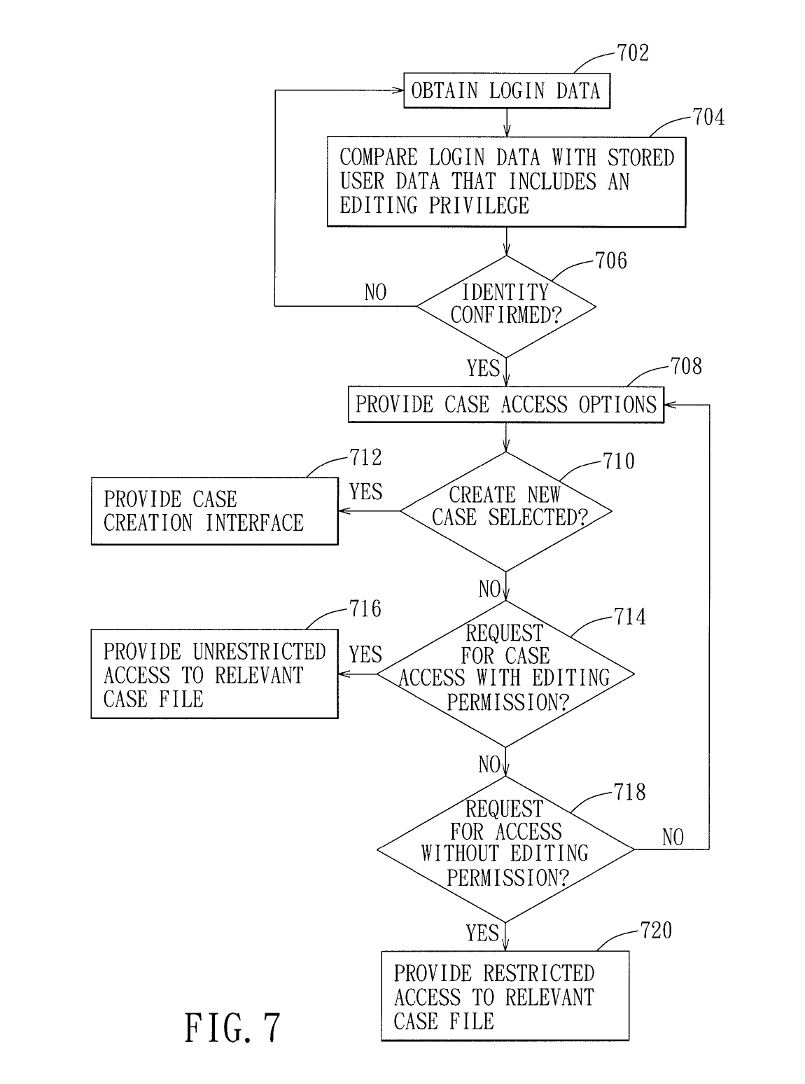

FIG. 7 is a flowchart of a preferred embodiment illustrating a login procedure. In step 702, login data is obtained. The login data may include an account information and a password. In an embodiment, login data of a user is input through a user terminal 106 and communicated to the computer system 102 and the identity recognition module 222 through the communications network 104.

In step 704, the login data is compared with stored user data 242 to determine access privilege data 244 that includes editing privilege data 246. The identity recognition module 222 may acquire the user data 242 from the identity database 230. The access privilege data 244 may permit access to different case files based on an affiliation with an entity such as a company, a client, or a law firm. The editing privilege data 246 permits editing access to a particular case file, parts of a case file, or editing with respect to edits generated using particular levels of editing privilege. For example, a supervisor may be allowed to revise or finalize edits made by a subordinate editor. Alternatively, an inventor may be permitted to comment or propose edits to a draft specification prepared by a patent practitioner while preserving the original content for reference purposes.

In step 706, if the login data is determined to be invalid, the process returns to step 702. If the login data corresponds to an access privilege data 244, then in step 708, case access options are provided. For example, as illustrated in FIG. 8, the entry interface 804 may be presented through the editing-communication interface 802.

In step 710, if an option to create a new case file is selected, then a case creation interface is provided in step 712 for inputting information, such as file name information, and account information of persons who are authorized to access the case file and to edit the case file. Alternatively, in step 714, whether or not a request for access to a previously established case file with editing permission (i.e., access a case file which the user has valid editing privilege) has been received is determined. If access has been requested, then in step 716, unrestricted access to the relevant case file is provided. Otherwise, in step 718, whether or not a request for access to a previously established case file without editing permission (i.e., access a case file which the user has access privilege but no editing privilege) has been received is determined. If access has been requested, then in step 720, restricted access to the relevant case file is provided. Otherwise, the flow returns to step 708.

FIG. 8 is an illustration of an entry interface 804 of an editing-communication interface 802 of a preferred embodiment. The entry interface 804 has an option 806 to establish a new case file, an option 808 to access an established case file without editing permission, and an option 810 to access an established case file with editing permission. As discussed with respect to FIG. 7, the options provided by the entry interface 804 through the editing-communication interface 802 may allow a user to create a new case file, view a case file with restricted editing permission (i.e., restricted access), or access a case file with editing permission (i.e., unrestricted access).

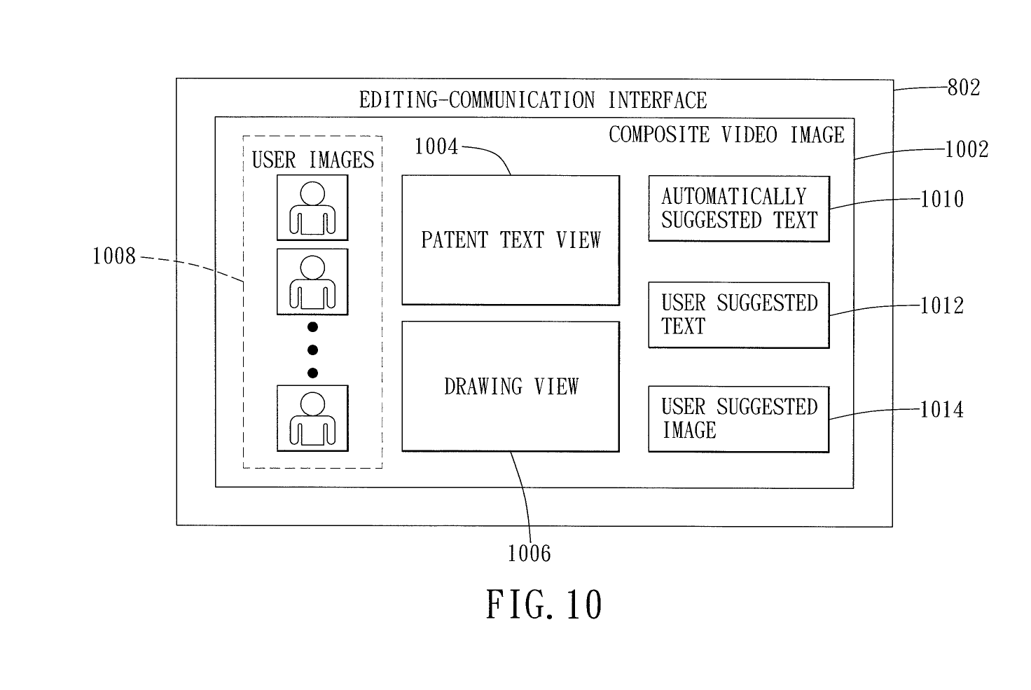

The appearance, layout, and content of the editing-communication interface 802, the entry interface 804, as well as the interfaces shown in FIGS. 10 to 13 is not limited to the illustrations as shown, which represent content and access options that may be provided through the editing-communication interface 802. In various embodiments, different appearances and additional or fewer options may be presented.

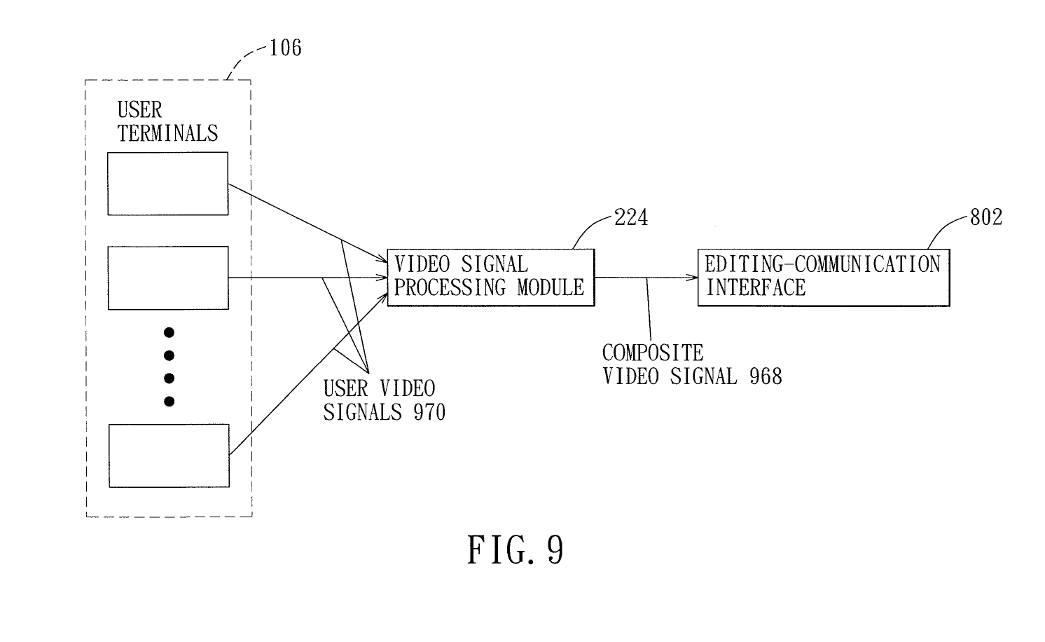

FIG. 9 is a block diagram illustrating communication of a composite video signal 968 between a video signal processing module 224 and an editing-communication interface 802 in accordance with a preferred embodiment. FIG. 9 shows user terminals 106, a video signal processing module 224, an editing-communication interface 802, a composite video signal 968, and user video signals 970.

The user video signals 970 may be transmitted from the user terminals 106 and received by the video signal processing module 224, which uses the user video signals 970 to generate the composite video signal 968. The editing-communication interface 802 acquires the composite video signal 968 for display to the users of the user terminals 106.

The user video signals 970 may include audio signals and video images of a user operating the computer system 102 or the user terminals 106. The composite video signal 968 may include the audio signals from each of the input user video signals 970.

FIG. 10 is an illustration of a composite video image 1002 of a preferred embodiment. FIG. 10 shows the editing-communication interface 802, the composite video image 1002, a patent text view 1004, a drawing view 1006, user images 1008, automatically suggested text 1010, a user suggested text 1012, and a user suggested image 1014.

The composite video image 1002 includes the user images 1008. The composite video signal 968 may be arranged and formatted by the video signal processing module 224 of the processing device 208 to display each of the user images 1008 within an available screen space of the composite video image 1002 based on the number of user video signals 970 being displayed. The patent text view 1004 and the drawing view 1006 may show parts of a draft patent application that are being cooperatively edited by multiple users through the editing-communication interface 802, with each participating user having restricted or unrestricted editing privileges.

For example, one user may be able to input text and drawings, accept or reject changes by other users, or review comments embedded within the draft of the text. Another user may be able to propose changes without making direct alterations to the text through either verbal suggestions, hand-drawn edits or comments, or suggested illustrations. An additional user may be limited to observing the editing process. Each of the users may see the edits, comments, and suggestions of the other users in real-time. In addition, the composite video image 1002 presented through the editing-communication interface 802 may be customized for each user, such as by limiting the number of other users viewed within the composite video image 1002.

Suggestions and proposed changes may be made through automatically suggested text 1010, a user suggested text 1012, and a user suggested image 1014. The automatically suggested text 1010 may include the result of a query by the word parsing module 218 to display words or terms with similar or otherwise related meanings to text being displayed within the patent text view 1004. The word parsing module 218 may build a query using a term that is beneath or near a user controlled pointer within the patent text view 1004.

The automatically suggested text 1010 may include text generated by the descriptive-text building module 216. The user suggested text 1012 and the user suggested image 1014 may include text and image edits, proposed changes, articles, cases, treatise information, prior art references, or other documents and images that may assist in preparing a patent application. The automatically suggested text 1010 may appear in a pop-up window or a dialog box.

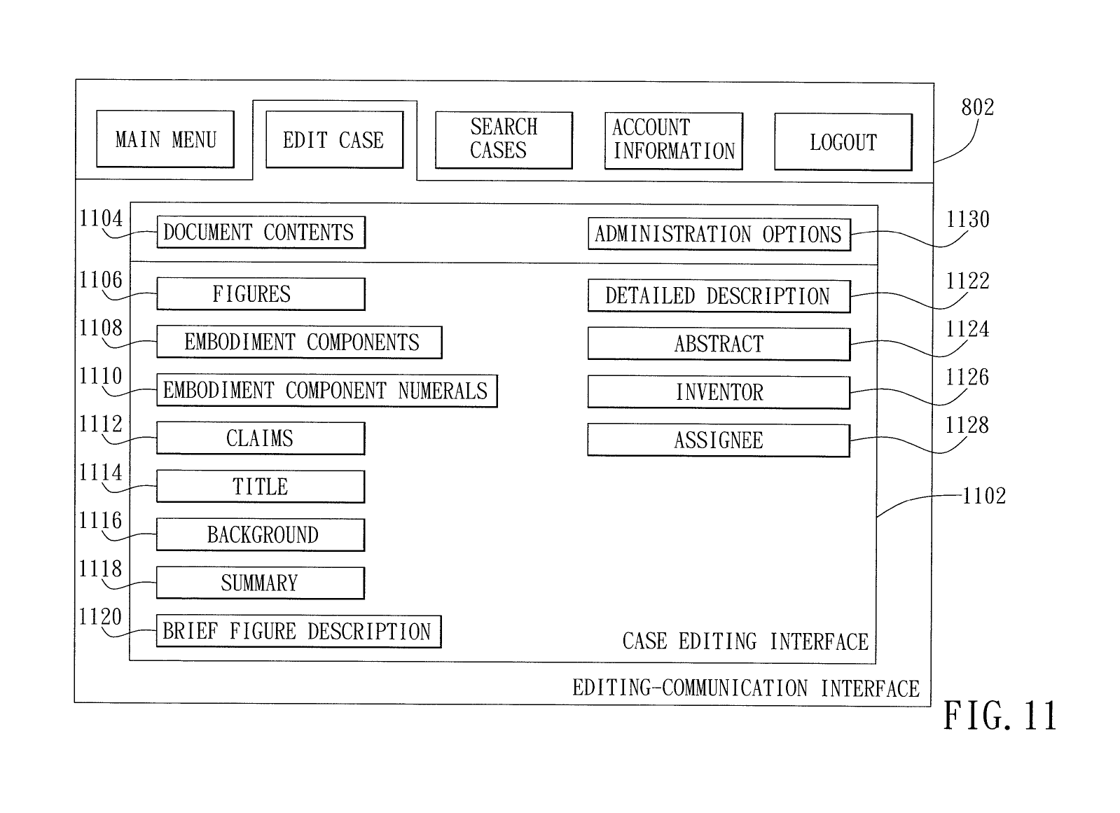

FIG. 11 is an illustration of a case editing interface 1102 of a preferred embodiment. FIG. 11 shows the case editing interface 1102 of the editing-communication interface 802 to have a view 1104 of document contents, and an option 1106 for figures, an option 1108 for embodiment components, an option 1110 for embodiment component numerals, an option 1112 for claims, an option 1114 for a title, an option 1116 for a background, an option 1118 for a summary, an option 1120 for a brief figure description, an option 1122 for a detailed description, an option 1124 for an abstract, an option 1126 for an inventor, an option 1128 for an assignee, and administration options 1130.

Each of the options included within the view 1104 of document contents may allow access through the editing-communication interface 802 to an associated view of a particular section or contents of a patent application. For example, the option 1112 for claims, the option 1114 for a title, the option 1116 for a background, the option 1118 for a summary, the option 1120 for a brief figure description, and the option 1122 for a detailed description, may each allow access to the corresponding section of the patent application. The option 1106 for figures, the option 1108 for embodiment components, and the option 1110 for embodiment component numerals may allow a user to upload, provide or edit figures, embodiment component descriptions, or component reference numerals 362, respectively. The option 1126 for an inventor, and the option 1128 for an assignee may allow a user to enter the identity of the relevant entities for the application.

Preferably, the case editing interface 1102 may further include options (not shown) for editing patent application forms.

FIG. 12 is an illustration of a specification editing interface 1202 of a preferred embodiment. The specification editing interface 1202 provided through the editing-communication interface 802 may be displayed within the patent text view 1004 and has an option 1204 to generate embodiment-descriptive text, and a specification view 1206. The option 1204 to generate embodiment-descriptive text may initiate operation of the descriptive-text building module 216 and begin construction of raw embodiment-descriptive text 360 based on one or more of the components, component reference numerals 362, component-descriptive text 364, or component images of an embodiment of an invention that is the subject of a patent application corresponding to the case file. The specification view 1206 displays specification text of the patent application.

FIG. 13 is an illustration of a claim editing interface 1302 of a preferred embodiment. The claim editing interface 1302 provided through the editing-communication interface 802 may be displayed within the patent text view 1004, and has an option 1304 for a new claim, an option 1306 for a claim tree, an option 1308 for a claim type, an option 1310 for a claim dependency, an option 1312 for a preamble, an option 1314 for a transitional phrase, an option 1316 for a functional clause, an option 1318 for a claim body, an option 1320 for annotations, and a claim group view 1322. The option 1304 for a new claim may allow entry of terms for an additional claim with the assistance of the inspecting module 220. The option 1306 for a claim tree may display a visual representation of a current claim dependency within a claim group. The option 1308 for a claim type may allow selection of a particular claim format, such as a Jepson claim. The option 1310 for a claim dependency may allow selection of an existing independent or dependent claim to act as a base claim for the edited dependent claim.

In addition, the option 1312 for a preamble, the option 1314 for a transitional phrase, the option 1316 for a functional clause, and the option 1318 for a claim body may allow editing of the corresponding parts of the dependent claim. The option 1316 for a functional clause allows editing of a sentence for defining a relationship among elements of an embodiment, such as a connection, a coupling, or an operational relationship.

The option 1320 for annotations may allow notes to be added, such as component reference numerals 362 or editor comments. The inspecting module 220 may be operated to automatically add or remove the component reference numerals 362 from the claims stored in the claim group data 252 in accordance with regional formatting preferences. The claim group view 1322 may provide a list of the claims within the current claim group or multiple claim groups being edited within the claim editing interface 1302.

In sum, this invention presents a computer system and method capable of providing assistance in the preparation of a patent application. In an embodiment, a plurality of users may participate in group drafting and/or editing of a patent document in real-time.

While the present invention has been described in connection with what are considered the most practical and preferred embodiments, it is understood that this invention is not limited to the disclosed embodiments but is intended to cover various arrangements included within the spirit and scope of the broadest interpretation to encompass all such modifications and equivalent arrangements.

What is claimed is:

1. A computer system capable of providing assistance in the preparation of a patent application, said computer system comprising:
a database group including
a case database for storing a case file, said case database including
a drawing data storage for storing at least one drawing of an embodiment of an invention that is the subject of a patent application and that corresponds to the case file, said at least one drawing including at least one component reference numeral,
a component description data storage for storing component-descriptive text of at least one component of the embodiment that corresponds to the case file, said at least one component corresponding to said at least one component reference numeral included in said at least one drawing stored in said drawing data storage, and
an invention description data storage for storing embodiment-descriptive text of the embodiment that corresponds to the case file; and
a processing device coupled to said database group, said processing device including
a descriptive-text building module for building raw embodiment-descriptive text that corresponds to the case file in accordance with a text-building rule and that is based on said at least one component reference numeral of said at least one drawing stored in said drawing data storage, and the component-descriptive text stored in said component description data storage, wherein said descriptive-text building module further stores the raw embodiment-descriptive text in said invention description data storage.

2. The computer system as claimed in claim 1, wherein said database group further includes a related term database for storing a group of entry terms and alternative terms corresponding to the entry terms, and wherein said processing device further includes a word parsing module for parsing input text to acquire a query term and searching said related term database to acquire at least one alternative term corresponding to the query term.

3. The computer system as claimed in claim 1, wherein said case database further includes a claim storage for storing a claim group corresponding to the case file, and said processing device further includes an inspecting module for inspecting each claim in the claim group stored in said claim storage according to at least one preset claim-drafting rule and for issuing a warning signal when an inspected claim in the claim group is found to be non-compliant with said at least one preset claim-drafting rule.

4. The computer system as claimed in claim 3, wherein said inspecting module issues the warning signal when the inspected claim is a dependent claim having a preamble that differs from a base claim on which the inspected claim depends.

5. The computer system as claimed in claim 1, wherein said descriptive-text building module builds the raw embodiment-descriptive text based on an ordered sequence of the components of the embodiment, the ordered sequence being dependent upon hierarchical relations among the component reference numerals corresponding to the components of the embodiment.

6. The computer system as claimed in claim 1, the computer system being capable of connecting to a user terminal through a communications network, wherein:
said database group further includes an identity database for storing user data of at least one user, the user data including an access privilege of a user for the case file stored in said case database; and
said processing device further includes an identity recognition module for comparing received login information from the user terminal with said user data stored in said identity database to determine whether a user of the user terminal is authorized to access the case file stored in said case database.

7. The computer system as claimed in claim 6, wherein the access privilege in the user data stored in said identity database includes an editing privilege and is configured when the case file is established.

8. The computer system as claimed in claim 7, wherein, in response to receipt of the login information from the user terminal, said identity recognition module provides an entry interface that includes options to establish a new case file, to access a previously established case file without editing permission, and to access a previously established case file with editing permission.

9. The computer system as claimed in claim 1, the computer system being capable of connecting to a plurality of user terminals through a communications network, wherein said processing device provides an editing-communication interface for use by users of the user terminals who are participating in group editing of the case file.

10. The computer system as claimed in claim 9, wherein said processing device includes a processor and a memory coupled to said processor, said memory having program instructions stored therein that, when executed, configure said processor to provide said editing-communication interface, said program instructions being written using a web page programming language.

11. The computer system as claimed in claim 9, wherein said processing device further includes a video signal processing module for receiving user video signals from the user terminals and for displaying a corresponding composite video signal screen through the editing-communication interface.

12. A computer-implemented method for providing assistance in the preparation of a patent application, comprising the steps of:
storing a case file in a case database, the case database including
a drawing data storage for storing at least one drawing of an embodiment of an invention that is the subject of a patent application and that corresponds to the case file, said at least one drawing including at least one component reference numeral,
a component description data storage for storing component-descriptive text of at least one component of the embodiment that corresponds to the case file, said at least one component corresponding to said at least one component reference numeral included in said at least one drawing stored in said drawing data storage, and
an invention description data storage for storing embodiment-descriptive text of the embodiment that corresponds to the case file; and
building, through a processing device, raw embodiment-descriptive text that corresponds to the case file in accordance with a text-building rule and that is based on said at least one component reference numeral of said at least one drawing stored in said drawing data storage, and the component-descriptive text stored in said component description data storage, wherein said processing device further stores the raw embodiment-descriptive text in said invention description data storage.

13. A computer program product comprising a computer readable storage medium having program instructions stored therein that, when executed, configure a general purpose computer to perform the computer-implemented method of claim 12.
